(19) United States
(12) Patent Application Publication
(10) Pub. No.: US 2003/0236727 A1
(43) Pub. Date: Dec. 25, 2003

(54) Enhanced techniques for generating and managing electronic investment contracts

(76) Inventors: Robert R. Champion, San Francisco, CA (US); Valere B. Costello, Sandy's (BM)

Correspondence Address: MORGAN LEWIS & BOCKIUS LLP, 1111 PENNSYLVANIA AVENUE NW, WASHINGTON, DC, 20004, US

(21) Appl. No.: 10/360,310

(22) Filed: Feb. 7, 2003

Related U.S. Application Data
(63) Continuation-in-part of application No. 09/802,026, filed on Mar. 8, 2001.

(51) Int. Cl. G06F 17/60

(52) U.S. Cl. 705/35

(57) ABSTRACT

A computerized method for generating an electronic investment contract. The electronic investment contract provides enhanced flexibility through the use of one or more investor-selectable asset exposure parameters linked to one or more investment asset categories. These asset exposure parameters may be specified in the form of an allocation parameter associated with a corresponding response parameter, or in the form of an investment-percentage-weight parameter, or in the form of an amount-of-asset-exposure parameter. More specifically, an investment identifier is used to uniquely specify a corresponding investment contract. Each of one or more investment identifiers is associated with an investment amount and one or more asset category identifiers. The asset category identifier uniquely specifies an investment asset category. Each of one or more asset category identifiers is associated with a corresponding asset exposure parameter. In implementations that employ allocation and response parameters, the allocation parameter specifies an allocation amount to be indexed to the corresponding asset category identifier, and the response parameter specifies a relationship between the allocation amount and any subsequent price and/or net worth changes in the corresponding investment asset category.

### RELATED CASES

The present application is a Continuation-In-Part of patent application Ser. No. 09/802,026 filed on Mar. 8, 2001.

### FIELD OF THE INVENTION

The invention relates generally to electronic financial management systems and methods, and, more specifically, to computer-based techniques for generating and managing investment contracts related to indexed investment vehicles.

### BACKGROUND OF THE INVENTION

In the past, investors have employed managed portfolios as primary investment vehicles. An ever-popular investment vehicle is the mutual fund, which permits investors to participate in capital markets with a minimum of effort. Mutual funds are administered by professional money managers who take fees as a percentage of the net asset value of the fund over a given time period. These fees are used to finance large research departments that sift through and select various investments for the funds. The management fee varies from fund to fund, but, as a general rule, it falls between 0.2% and 1.5% of the net asset value of the fund. From a legal standpoint, mutual funds represent an ownership cooperative of selected securities. Participating investors are charged with many of the legal responsibilities of owning securities, without the attendant control thereof. If the fund invests in the stock market, investors are essentially bearing the diversifiable risk of positions in a limited number of stocks.

Despite the fact that mutual funds are managed by financial experts, it is an unfortunate practical reality that a significant percentage of these funds fail to outperform the general equity markets. Past studies indicate that a significant percentage of all managed funds were outperformed by the Standard and Poor's (S&P's) 500® Composite Stock Price Index. The S&P 500 Index is a relative valuation of the stocks of 500 large companies, most of which are listed and traded on the New York Stock Exchange, and is considered to be a general indicator of the performance of the US equity markets. The lackluster performance of managed funds has generated substantial interest in investment products that track the overall performance of the equity markets while, at the same time, being unencumbered by asset research fees and high transaction costs. For example, indexed stock funds are presently available that invest in the stocks of the S&P 500 companies and, therefore, directly track the performance of the S&P 500 Index.

A current trend is for investors to take an increasingly active role in managing their wealth. At the same time, capital investment markets have experienced dramatic fluctuations in response to changing economic, political, and financial conditions. This has created a global investment environment characterized by rapidly changing inflationary expectations, unpredictable interest rates, volatile exchange rates, and a fully internationalized capital marketplace. Traditional investment vehicles, such as stocks, bonds, and mutual funds are being supplanted by newer, more flexible investment vehicles that provide investors with enhanced opportunities to actively manage their investments. These versatile products include “beta” funds and exchange-traded funds (ETFs).

A “beta” fund is a special type of mutual fund that is linked to one or more major market indices, such as the S&P 500. In Bermuda, the Bank of Bermuda presently offers “beta” funds referred to as their “All Points Index Funds”. In the U.S., other “beta” funds are offered by Rydex, Profunds, and Potomac. These funds offer leveraged as well as inverse exposures to one or more major market indices. A significant degree of flexibility is provided, in that no limits are placed on switching. Liability is limited, and leverage is provided at low cost.. Over the past several years, “beta” funds have enjoyed explosive growth. For example, Rydex has expanded from $600 million (1995) to 9 billion (2000). ProFunds have increased from $400 million (1998) to $3 billion (2000).

Exchange-traded funds (ETFs) are index-based trusts listed on a major international stock exchange, such as the American Stock Exchange. Each of these trusts aggregates “baskets” of stocks of a representative equity index. Illustrative ETFs include SPDRs, DIAMONDS, QQQs, and WEBs. In general, ETFs permit intra-day trading, and provide the investor with a precise or desired level of risk exposure. As was the case with beta funds, ETFs have also enjoyed explosive growth. The aggregate growth of SPDRs, DIAMONDS, QQQs and WEBs has increased from $1 billion in 1994 to $40 billion in 2000.

Despite the recent popularity of beta funds and ETFs, these investment vehicles are not sufficiently flexible for many investors. With respect to beta funds, it is currently not possible to trade more than twice a day. And it is unduly cumbersome for the investor to obtain a precise or desired level of risk exposure. Although ETFs provide precise levels of risk exposure and permit investors to engage in intra-day trading, they expose short-selling investors to unlimited liability. A further shortcoming of ETFs is that they do not provide a high degree of leveraging at low cost. Accordingly, there is a need for an investment vehicle that provides an enhanced degree of flexibility relative to presently-existing alternatives.

### SUMMARY AND OBJECTS OF THE INVENTION

It is an object of the invention to provide an electronically generated investment instrument that offers enhanced flexibility relative to presently-existing alternatives.

It is also an object of the invention to provide an electronically generated investment instrument that enables an investor to specify a desired level of asset exposure.

It is a further object of the invention to provide an electronically generated investment instrument where the level of asset exposure is set forth by specifying an allocation parameter associated with a response parameter; or, by specifying an investment-percentage-weight parameter; or, by specifying an amount-of-asset-exposure parameter.

It is also an object of the invention to provide an Internet-based, Intranet-based, and/or wireless system for managing and tracking the electronically generated investment instrument.

It is yet another object of the invention to provide an Internet-accessible mechanism for accurately monitoring and adjusting the level of risk for a given investment instrument.

It is still another object of the invention to provide an Internet-accessible graphical user interface for receiving investor requests related to the electronically generated investment instrument, such as requests that involve any of asset selection, risk adjustment, deposits, and/or withdrawals.

It is yet another object of the invention to respond to investor requests such that the net position of an investor's electronically generated investment instrument reflects a level of risk desired by that investor.

The above and other objects of the invention are realized in the form of computerized methods for generating an electronic investment contract. The electronic investment contract provides enhanced flexibility through the use of one or more investor-selectable asset exposure parameters linked to one or more investment asset categories. These asset exposure parameters may be specified in the form of an allocation parameter associated with a corresponding response parameter, or in the form of an investment-percentage-weight parameter, or in the form of an amount-of-asset-exposure parameter. More specifically, an investment identifier is used to uniquely specify a corresponding investment contract. Each of one or more investment identifiers is associated with an investment amount and one or more asset category identifiers. The asset category identifier uniquely specifies an investment asset category. Each of the one or more asset category identifiers is associated with an asset exposure parameter. The asset exposure parameter sets forth at least one of: (a) a corresponding allocation parameter and a corresponding response parameter; (b) an investment-percentage-weight parameter, and (c) an amount-of-net-asset-exposure parameter.

An allocation parameter specifies an allocation amount to be indexed to the corresponding asset category identifier, and a response parameter associated with this allocation parameter specifies a relationship between the allocation amount and any subsequent price and/or relative valuation changes in, and/or any net worth changes relating to, the corresponding investment asset category. This relationship could be positive (long), or negative (short), and also could be one-to-one (non-leveraged) or with an absolute value greater than one-to-one (leveraged).

Alternatively, an asset category identifier is associated with an investment-percentage-weight parameter that, when multiplied by the associated investment amount, yields an amount of asset exposure to the associated asset category. The amount of asset exposure is responsive to any subsequent price and/or relative valuation changes in, and/or any net worth changes relating to, the corresponding investment asset category. This investment-percentage-weight parameter could be positive (long) or negative (short). The sum of the absolute values of all investment-percentage-weight parameters among all asset category identifiers for a given investment identifier could be 100%, or greater than 100%. A sum of 100% indicates no leveraging of the investment contract corresponding to the investment identifier, whereas a sum greater than 100% indicates leveraging of this investment contract.

And, alternatively, an asset category identifier is associated with a parameter indicative of an amount of asset exposure to the associated asset category. This amount-of-asset-exposure parameter is responsive to a subsequent price and/or relative valuation change in, and/or net worth change relating to, the corresponding investment category. The amount-of-asset-exposure parameter could be positive (long), or negative (short). The sum of the absolute values of the amount-of-asset exposure parameters among all asset category identifiers for a given investment identifier could equal the corresponding investment amount, or could be greater than the corresponding investment amount. In cases where the sum is equal to the corresponding investment amount, this indicates no leveraging of the investment contract corresponding to the investment identifier. However, if the sum is greater than the corresponding investment amount, this indicates a leveraging of the investment contract.

Pursuant to a further embodiment of the invention, the electronic investment contracts are managed by means of an Internet-accessible graphical user interface. The user interface provides a mechanism by which each asset category of one or more investment contracts can be maintained at a selected level of risk. Risk may be specified in terms of an amount and/or percentage of money that is then associated with a multiplicative factor to be applied to the market return of that asset category. Alternatively, risk may be specified by an investment-percentage-weight parameter or by a direct amount-of-asset-exposure parameter. When a multiplicative factor is used, asset exposure (risk) is determined by multiplying the aforementioned amount and/or percentage of money by the multiplicative factor. In the latter instance, asset exposure is determined by the multiplicative factor. When an investment-percentage-weight parameter is used, asset exposure is determined by multiplying the aforementioned investment-percentage-weight parameter by the corresponding investment amount. Asset exposure and, thus, risk, is established directly when the amount-of-asset-exposure parameter is used.

The graphical user interface mechanism is coupled to a data processing mechanism that calculates an aggregate level of risk in a given asset category among a plurality of investment contracts. Based upon the aggregate level of risk, the data processing mechanism establishes an aggregate position, via possible implementation of purchases or sales of individual securities, purchases or sales of futures contracts in selected market indices, or other financial transactions related to that asset category. Electronic investment contract funds may also be invested in a mix of income-bearing instruments, such as U.S. Treasury Notes. As the investor changes the desired level of risk or makes deposits and withdrawals, the data processing mechanism automatically adjusts the parameters related to the corresponding investment contract, and automatically initiates any required market transaction in the relevant asset category. Based upon market prices, the exposure and net asset value of each investment contract is updated. Optionally, an administration fee may be charged.

Periodically, or from time to time, or at one or more predetermined times, the data processing mechanism calculates a return for the electronic investment contract. If the contract is indexed to one or more stock indices, this return encompasses all, some, or none of the dividends on the stock index that would have been paid had the investor invested directly in this stock index. If the electronic investment contract is indexed to one or more futures contracts, this return encompasses some, all, or none of the interest that would have been earned on the amount of collateral deposited for the futures contract.

According to a still further embodiment of the invention, the graphical user interface provides a conditional order entry mechanism adapted to accept conditional (if-then) orders from an investor. The graphical user interface then forwards the conditional if-then order to the data processing mechanism. The data processing mechanism responds to conditional if-then investor requests such that, only upon the occurrence of the condition specified by the investor, one or more asset category identifiers and asset exposure parameters pertaining to the investor's investment contract are added or modified. In this manner, the net position of the investment contract reflects the level of risk desired by the investor.

### BRIEF DESCRIPTION OF THE DRAWINGS

The foregoing features of the present invention may be more fully understood from the following detailed discussion of specific illustrative embodiments thereof, presented below in conjunction with the accompanying drawings, in which:

FIG. 1 is a hardware block diagram setting forth an illustrative implementation for a system designed to generate and manage electronic investment contracts.

FIG. 2 is a diagram setting forth an illustrative data structure for an investment identifier lookup table.

FIGS. 3A, 3B, and 3C set forth three illustrative data structure diagrams for an investment contract records database.

FIGS. 4A and 4B together constitute a diagram setting forth an illustrative data structure diagram for a Country-Asset Category-Exchange Table.

FIG. 5 is a diagram setting forth an illustrative data structure for a set of investor-defined if-then templates.

FIGS. 6A and 6B are information flow diagrams setting forth various types of data that may be received by, and/or transmitted to, the Investment Contract Web Site of FIG. 1.

FIGS. 7A-7C are information flow diagrams setting forth data flow for the processes of accepting applications, receiving investment requests, and approving initial investments.

FIGS. 8A-8B together comprise a flowchart setting forth an operational sequence for generating and managing electronic investment contracts.

FIG. 9 is a flowchart setting forth a high-level operational sequence for managing investment contracts.

FIG. 10 is a screen-capture diagram showing an illustrative graphical user interface provided by the system of FIG. 1.

### DETAILED DESCRIPTION OF THE PREFERRED EMBODIMENTS

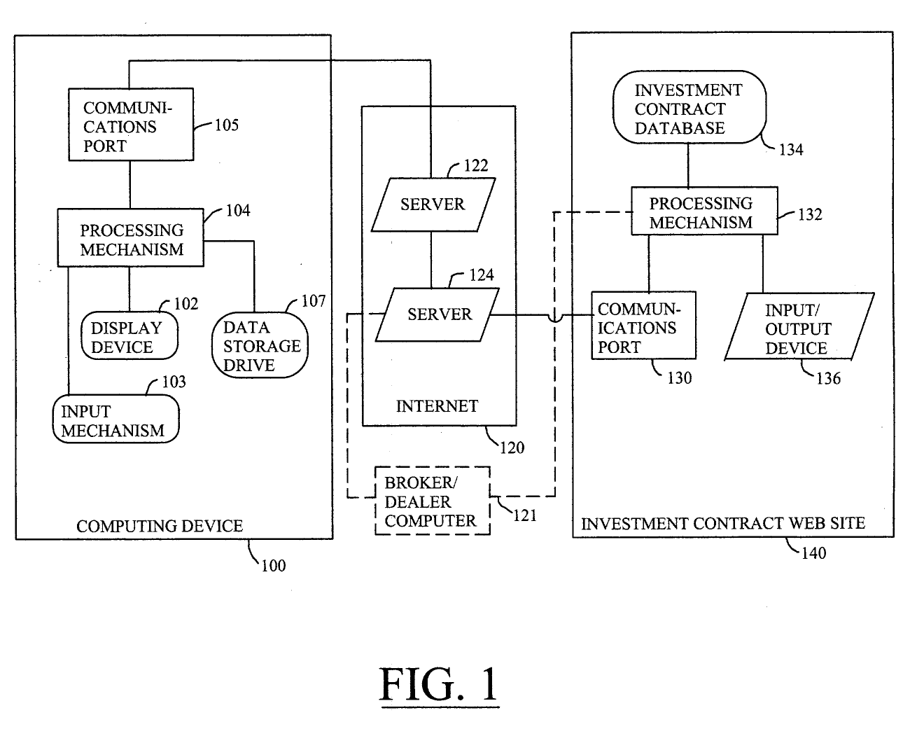

In overview, the invention provides computerized methods for generating electronic investment contracts. Refer to FIG. 1, which is a hardware block diagram setting forth an illustrative implementation for a system equipped to generate and manage these investment contracts. An investment contract Web site 140 includes an investment contract database 134 coupled to a processing mechanism 132. Investment contract database 134 can be implemented using any device adapted for the storage of information, whether by electronic, mechanical, magnetic, optical, or other means, or various combinations thereof. For example, one or more computer hard drives could be used to implement investment contract database 134, as could a read/write CD-ROM device, a magnetic tape backup unit, and/or electronic RAM (random access memory).

Processing mechanism 132 represents any electronic device equipped to process data and to access the investment contract database 134. A personal computer, a mainframe computer, and/or a microprocessor could be employed for processing mechanism 132. Investment contract database 134 and processing mechanism 132 could, but need not, represent discrete elements. For example, if a personal computer is used to implement processing mechanism 132, the hard drive of this personal computer could function as investment contract database 134.

Processing mechanism 132 is coupled to a communications port 130. Communications port 130 represents a port which conveys electronic communications between processing mechanism 132 and Internet 120. An input/output device 136 is coupled to processing mechanism 132. This input/output device 136 represents one or more devices capable of sending information to, and/or receiving information from, processing mechanism 132. Examples of suitable input/output devices are computer keyboards, display screens, floppy disk drives, optical disk drives, tape backup units, computer mice, tracking balls, smart card readers, magnetic strip readers, bar code readers, and others.

Communications port 130 is coupled to Internet 120. This coupling could, but need not, be implemented using modems, conventional twisted-pair telephone lines, Ethernet connections, ISDN lines, fiber-optic cable, coaxial cable, and/or any of various wireless devices such as spread-spectrum transceivers or wireless modems. Internet 120 may be conceptualized as containing a network of linked servers, such as servers 122 and 124. Optionally, a broker/dealer computer 121 can interface with processing mechanism 132 of investment contract Web site 140, and/or with server 124 directly over Internet 120.

Server 122 of Internet 120 is coupled to a communications port 105 of a computing device 100. Computing device 100 represents a device by which an individual such as a user, manager, customer, investor, and/or administrator interacts with the investment contract Web site 140. Computing device 100 includes a data storage drive 107 coupled to a processing mechanism 104. Data storage drive 107 can be implemented using any device adapted for the storage of information, whether by electronic, mechanical, magnetic, optical, or other means, or various combinations thereof. For example, one or more computer hard drives could be used to implement data storage drive 107, as could a read/write CD-ROM device, a magnetic tape backup unit, and/or electronic RAM (random access memory).

Processing mechanism 104 represents any electronic device equipped to process data and to access data storage drive 107. A personal computer, a laptop computer, a mainframe computer, and/or a microprocessor could be employed for processing mechanism 104. Data storage drive 107 and processing mechanism 104 could, but need not, represent discrete elements. For example, if a personal computer is used to implement processing mechanism 104, the hard drive of this personal computer could function as data storage drive 107.

Processing mechanism 104 is coupled to a communications port 105. Communications port 105 represents a port which conveys electronic communications between processing mechanism 104 and Internet 120. An input mechanism 103 and a display device 102 are coupled to processing mechanism 104. Input mechanism 103 represents one or more devices capable of sending information to processing mechanism 104, and display device 102 represents one or more devices capable of receiving and displaying information from processing mechanism 104. Input mechanism 103 and display device 102 could, but need not, be separate devices. Examples of suitable input devices for input mechanism 103 are computer keyboards, touch screens, floppy disk drives, optical disk drives, tape backup units, computer mice, tracking balls, smart card readers, magnetic strip readers, bar code readers, and others. Examples of suitable output devices for display device 102 are computer display screens, voice synthesizers, LCD displays, LED displays, audio annunciators, and others.

Communications port 105 is coupled to the Internet 120. This coupling could, but need not, be implemented using modems, conventional twisted-pair telephone lines, Ethernet connections, ISDN lines, fiber-optic cable, coaxial cable, and/or any of various wireless devices such as spread-spectrum transceivers or wireless modems.

It is to be understood that the hardware configuration of FIG. 1 is presented only for purposes of illustration. Clearly, the skilled artisan may envision any number of modifications, alternatives, additions, and/or simplifications to the hardware scheme of FIG. 1. All such variations are intended to be within the spirit and scope of the invention.

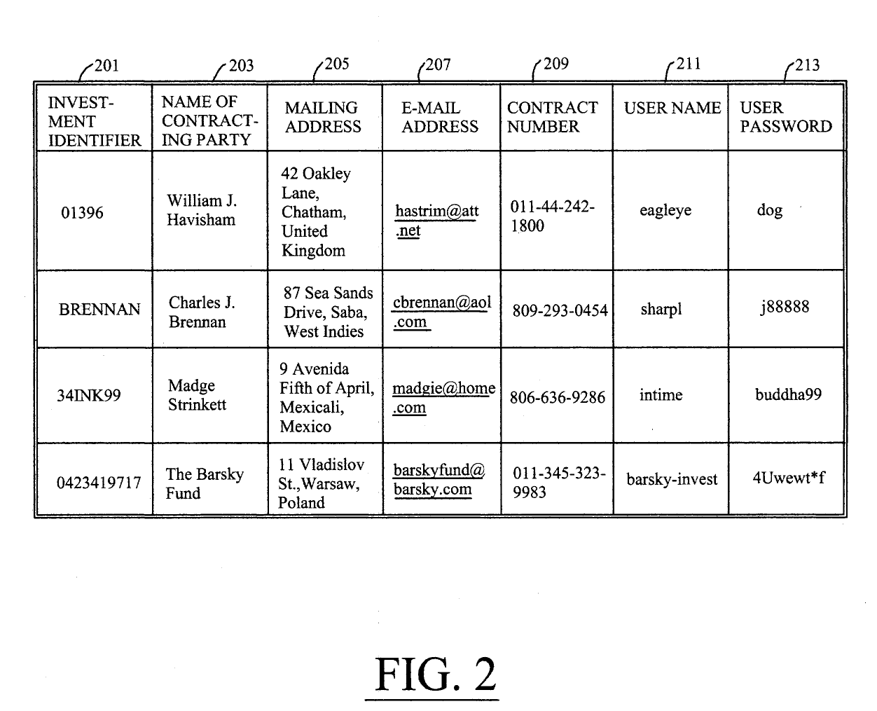

Refer now to FIG. 2, which is a diagram setting forth an illustrative data structure for an investment identifier lookup table. An investment identifier, specified in investment identifier 201 field, is used to uniquely specify a corresponding investment contract. In practice, a sequence of numbers (01396), alphanumeric codes (341NK99), alphabetic characters (WJKL), combinations thereof (94WJKL), and/or personal names (Brennan) could be used as investment identifiers. Each of a plurality of investment identifiers is associated with the name of a contracting party, stored in a “name of contracting party” 203 field. The name of the contracting party can be a personal name, such as Madge Strinkett, or it can indicate the name of another investing entity, such as the Barsky Fund. The mailing address of the contracting party is stored in a mailing address 205 field, their e-mail address is stored in an e-mail address 207 field, and their contact telephone number is stored in a contact number 209 field. Each contracting party may be assigned, or may select and/or specify: (i) a user name that is stored in user name 211 field, and (ii) a user password that is stored in user password 213 field.

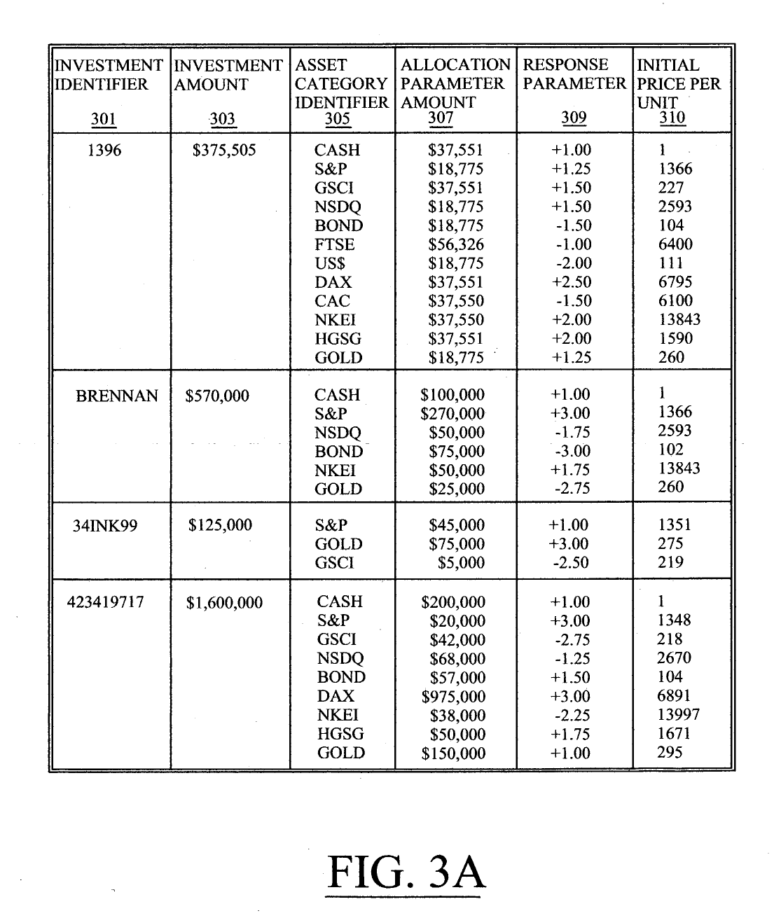

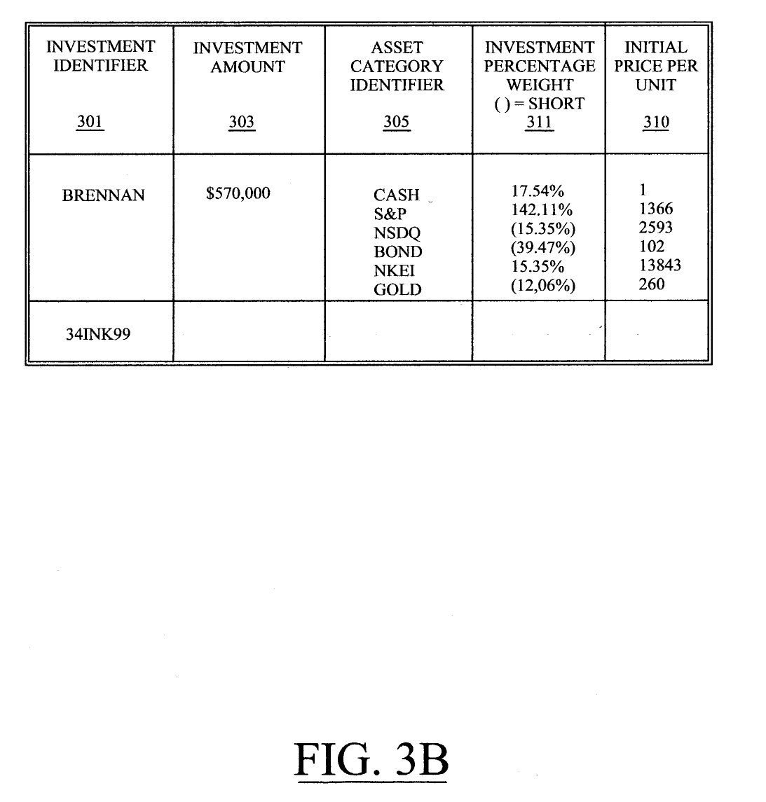

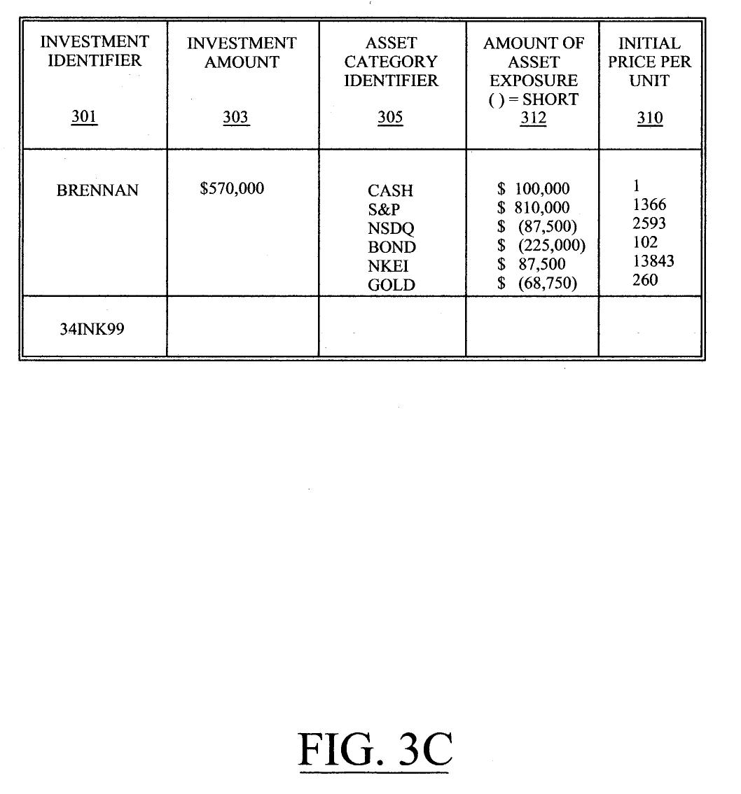

FIGS. 3A, 3B, and 3C set forth three illustrative data structure diagrams for an investment contract records database. With reference to the example of FIG. 3A, each of one or more investment identifiers (stored in Investment Identifier 301 field) is associated with an investment amount (stored in Investment Amount 303 field) and one or more asset category identifiers (stored in Asset Category Identifier 305 field). Electronic investment contracts are financial instruments that provide investors with enhanced flexibility through the use of one or more investor-selectable asset exposure parameters which, in the present example, include allocation parameters and/or amounts (stored in Allocation Parameter/Amount 307 field), as well as investor-selectable response parameters (stored in Response Parameter 309 field). These allocation and response parameters are linked to one or more investor-selectable investment asset categories stored in Asset Category Identifier 305 field. In other words, the asset category identifier uniquely specifies an investment asset category, and it is associated with a corresponding allocation parameter and a corresponding response parameter. The allocation parameter specifies an allocation amount to be indexed to the corresponding asset category identifier, and the response parameter specifies a relationship between the allocation amount and any subsequent price and/or relative valuation changes in, and/or net worth changes relating to, the corresponding investment asset category. An Initial Price Per Unit 310 field is used to store initial and/or reference prices for each of one or more asset category identifiers.

Referring now to the example of FIG. 3B, each of one or more investment identifiers (stored in Investment Identifier 301 field) is associated with an investment amount (stored in Investment Amount 303 field) and one or more asset category identifiers (stored in Asset Category Identifier 305 field). Electronic investment contracts are financial instruments that provide investors with enhanced flexibility through the use of one or more investor-selectable asset exposure parameters which, in the present example, include one or more investment-percentage-weight parameters stored in an Investment Percentage Weight 311 field. An Initial Price Per Unit 310 field is used to store initial and/or reference prices for each of one or more asset category identifiers. The investment-percentage-weight parameters are linked to one or more investor-selectable investment asset categories stored in Asset Category Identifier 305 field. In other words, the asset category identifier uniquely specifies an investment asset category, and it is associated with a corresponding investment-percentage-weight parameter.

The corresponding investment-percentage-weight parameter, when multiplied by the associated investment amount, yields an amount of asset exposure to the associated asset category. The amount of asset exposure is responsive to any subsequent price and/or relative valuation changes in, and/or any net worth changes relating to, the corresponding investment asset category. This investment-percentage-weight parameter could be positive (long) or negative (short). The sum of the absolute values of all investment-percentage-weight parameters among all asset category identifiers for a given investment identifier could be 100%, or greater than 100%. A sum of 100% indicates no leveraging of the investment contract corresponding to the investment identifier, whereas a sum greater than 100% indicates leveraging of this investment contract.

With reference to the example of FIG. 3C, each of one or more investment identifiers (stored in Investment Identifier 301 field) is associated with an investment amount (stored in Investment Amount 303 field) and one or more asset category identifiers (stored in Asset Category Identifier 305 field). Electronic investment contracts are financial instruments that provide investors with enhanced flexibility through the use of one or more investor-selectable asset exposure parameters which, in the present example, include one or more amount-of-asset-exposure parameters stored in an Amount of Asset Exposure 312 field. An Initial Price Per Unit 310 field is used to store initial and/or reference prices for each of one or more asset category identifiers. The amount-of-asset-exposure parameters are linked to one or more investor-selectable investment asset categories stored in Asset Category Identifier 305 field. In other words, the asset category identifier uniquely specifies an investment asset category, and it is associated with a corresponding amount-of-asset-exposure parameter.

The amount-of-asset-exposure parameter is responsive to a subsequent price and/or relative valuation change in, and/or net worth change relating to, the corresponding investment category. Moreover, the amount-of-asset-exposure parameter could be positive (long), or negative (short). The sum of the absolute values of the amount-of-asset exposure parameters among all asset category identifiers for a given investment identifier could equal the corresponding investment amount, or could be greater than the corresponding investment amount. In cases where the sum is equal to the corresponding investment amount, this indicates no leveraging of the investment contract corresponding to the investment identifier. However, if the sum is greater than the corresponding investment amount, this indicates a leveraging of the investment contract.

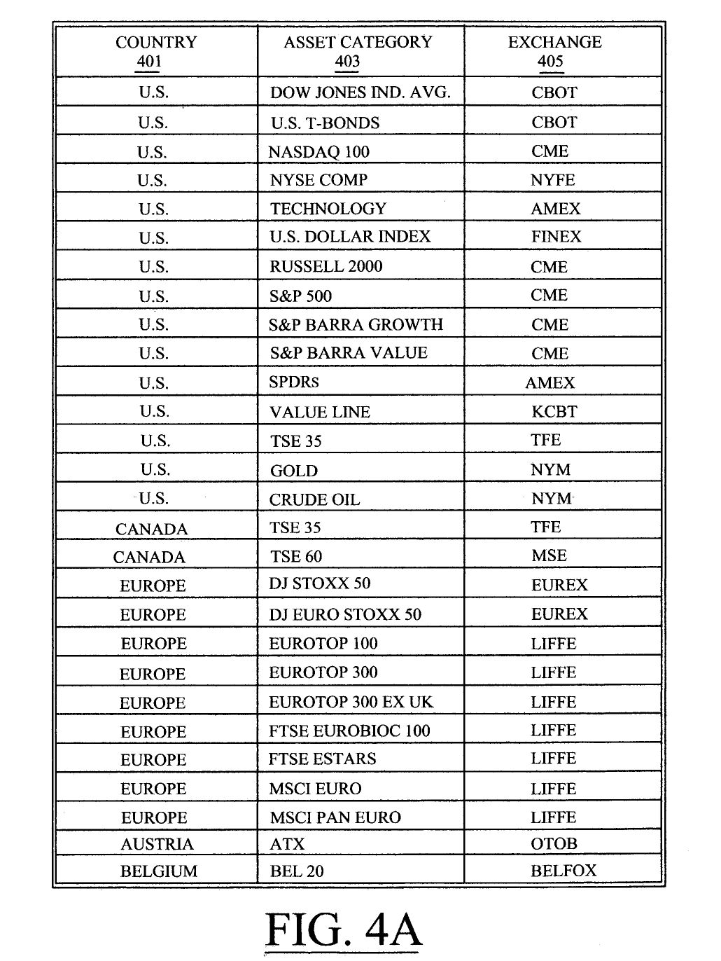

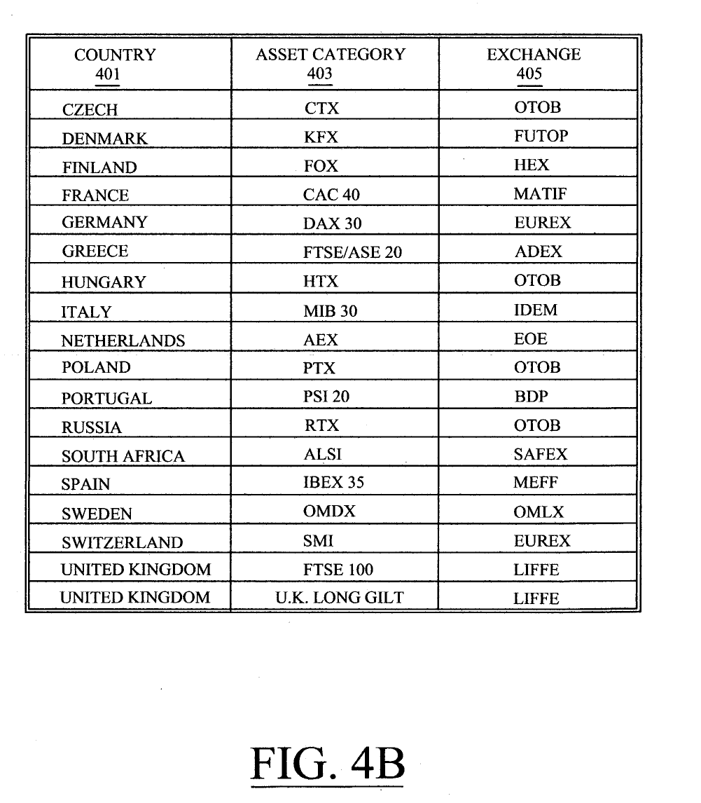

FIGS. 4A and 4B together constitute a diagram setting forth an illustrative data structure for a Country-Asset Category-Exchange Table. This Table stores information related to the Asset Category Identifiers previously described in conjunction with FIG. 3. More specifically, each of a plurality of financial asset categories (stored in Asset Category 403 field) is associated with a corresponding country (stored in Country 401 field) and a corresponding exchange (stored in Exchange 405 field). For example, the Dow Jones Industrial Average is an Asset Category that is associated with the Chicago Board of Trade in the United States.

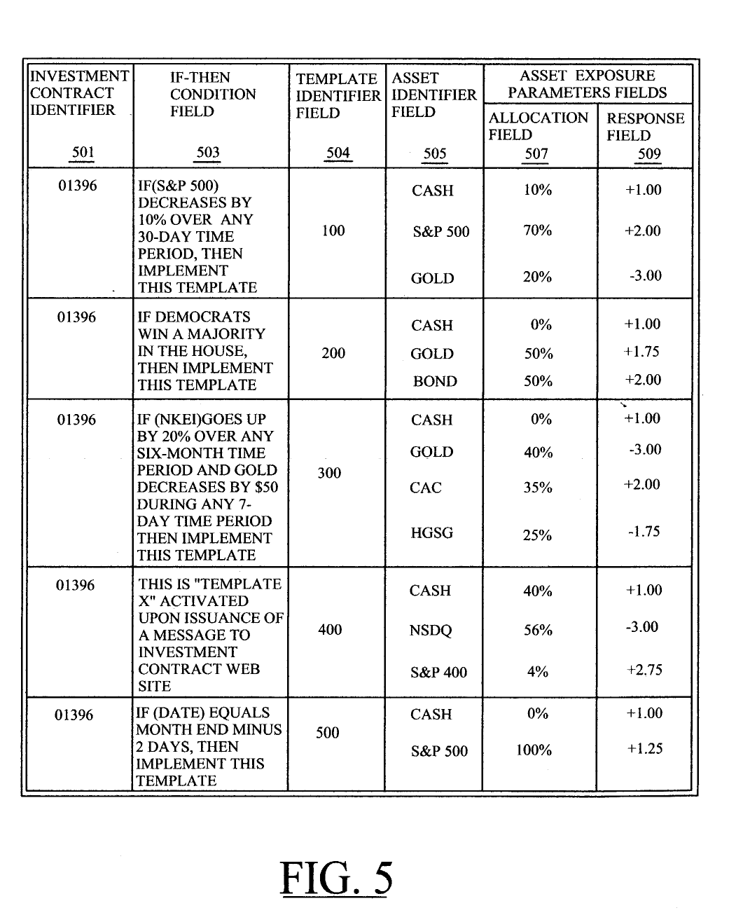

FIG. 5 is a diagram setting forth an illustrative data structure for a set of investor-defined if-then templates. More specifically, note that the investment contract Web site of FIG. 1 may be equipped to provide a conditional order entry mechanism for accepting conditional if-then orders from an investor. The conditional if-then order is forwarded to the data processing mechanism upon receipt. The data processing mechanism responds to conditional if-then investor requests such that, only upon the occurrence of the condition specified by the investor, one or more asset category identifiers and asset exposure parameters pertaining to the investor's investment contract are added or modified. In this manner, the net position of the investment contract reflects the level of risk desired by the investor.

The if-then templates of FIG. 5 include an Investment Contract Identifier 501 Field that associates a specified investment contract with one or more corresponding if-then conditions, asset identifiers, and asset exposure parameters. In the present example, asset exposure parameters are provided in the form of a respective plurality of allocation parameters each associated with a corresponding response parameter. However, other types of asset exposure parameters may be employed, including any of those previously described in conjunction with FIGS. 3A, 3B, and 3C. Moreover, the templates of FIG. 5 could include any combination of the asset exposure parameters described in FIGS. 3A, 3B, and 3C.

If-then conditions, stored in If-Then Condition 503 Field, are user-specified and/or user-selected. The if-then condition can include any of a number of logical conditions, such as “Implement this template if: (a) the Nikkei Index increases by 20% over any six-month period, and (b) Gold decreases by $50 during any 7-day period”. Information from any of various databases may be inputted, scanned, accessed, and/or reviewed to determine the presence or absence of any of these conditions. Asset identifiers are stored in Asset Identifier 505 field, and asset exposure parameters are stored in an Asset Exposure Parameters field which, in the present example, includes an Allocation Field 507 for storing allocation parameters, and a Response Field 509 for storing response parameters.

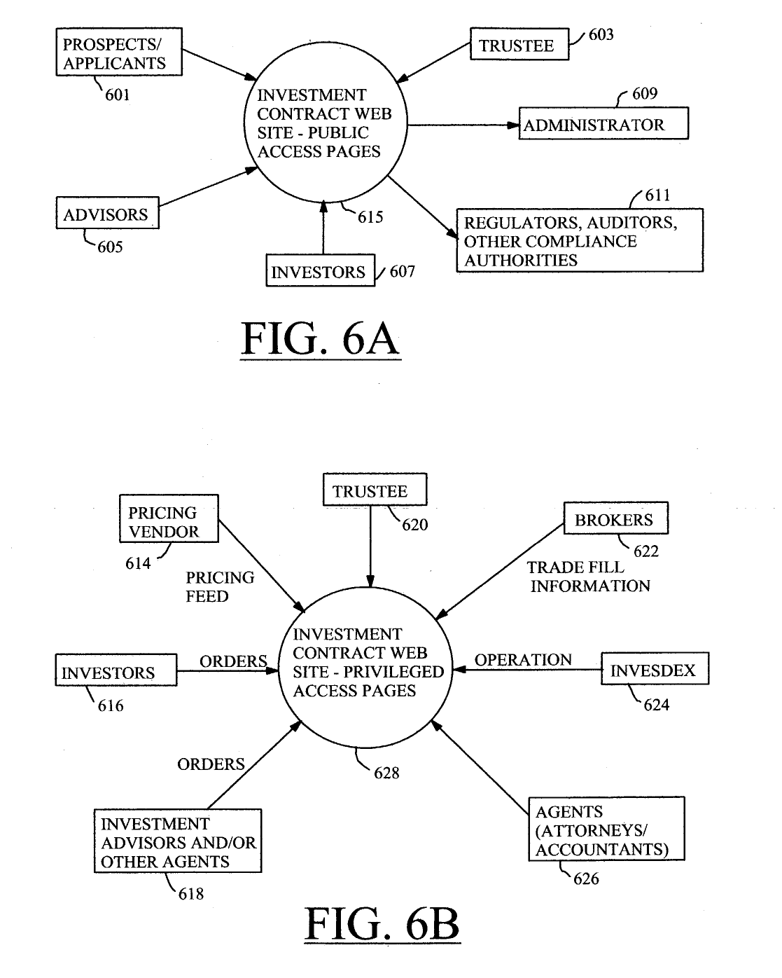

FIGS. 6A and 6B are information flow diagrams setting forth various types of data that may be received by, and/or transmitted to, the Investment Contract Web Site of FIG. 1. The Investment Contract Web Site may be programmed to provide a set of publicly-accessible Web pages as well as a set of privately-accessible Web pages. The publicly-accessible Web pages are accessible from virtually any Internet-enabled endpoint device, whereas the privately accessible Web pages may only accessed via passwords and/or via secure endpoint devices. The publicly accessible portion of the Web site is depicted in FIG. 6A as Investment Contract Web Site—Public Access Pages 615, and the privately accessible portion of the Web site is depicted in FIG. 6B as Investment Contract Web Site - Privileged Access Pages 628.

With respect to Public Access Pages 615, incoming information may be received from prospects/applicants 601, trustees 603, advisors 605, and investors 607. Outgoing information may be transmitted to entities such as administrators 609 and regulators, auditors, and other compliance authorities 611. The Privileged Access Pages 628 are accessed by pricing vendors 614, investors 616, advisors 618, trustees 620, brokers 622, other agents 626, and corporate entities such as Invesdex 624. Pricing vendors 614 input pricing feed information into the Web site. Investors 616 provide order information, and brokers 622 provide trade fill information. Advisors supply orders, and corporate entities such as Invesdex provide operational details. Agents 626 may include entities such as accountants and/or attorneys.

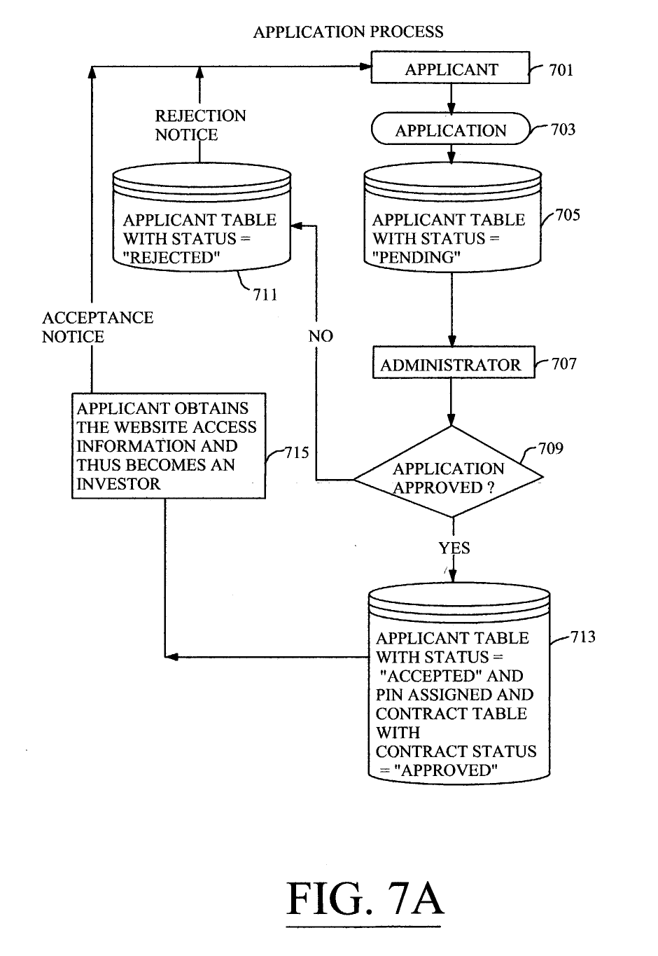

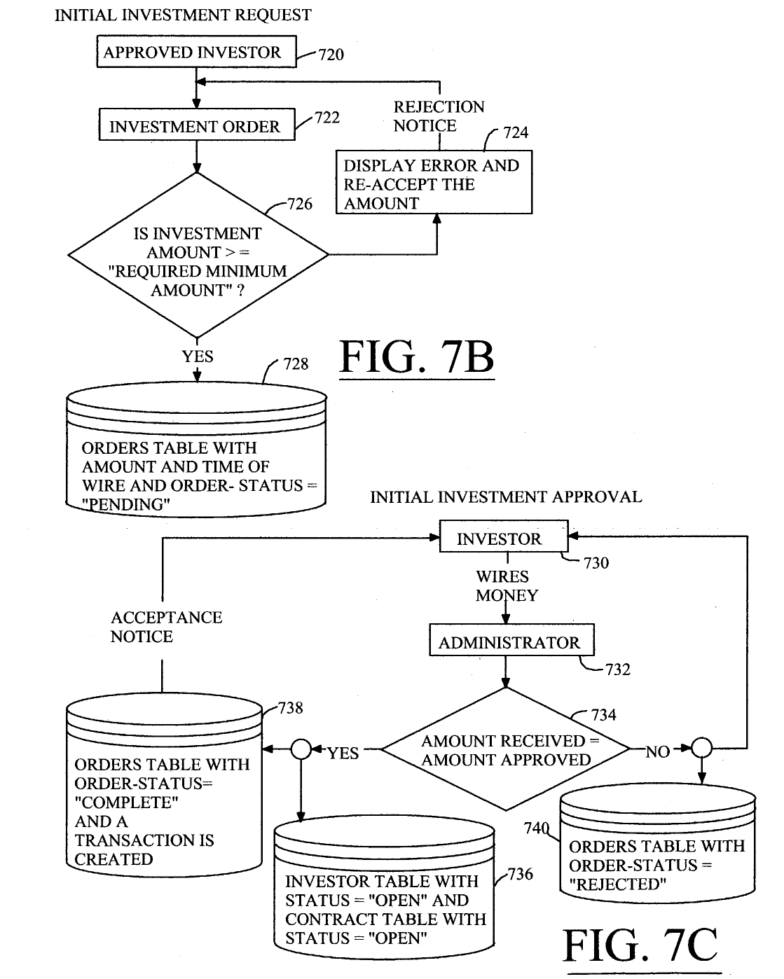

FIGS. 7A-7C are information flow diagrams setting forth the manner in which data are exchanged during the processes of accepting applications, receiving investment requests, and approving initial investments. During the application acceptance process (FIG. 7A), an applicant at block 701 (such as an individual investor) sends an electronic application (block 703) to the Investment Contract Web Site, whereupon the application is stored in an Applicant Table. Initially, the stored application is associated with a status flag set to “pending” (block 705). The pending electronic application is forwarded to an Administrator (block 707), which may be a bank or other financial institution. If the application is not approved (block 709), the status flag in the Applicant Table is set to “Rejected” (block 711). On the other hand, if the application is approved, the status flag in the Applicant Table is set to “Accepted”, and a PIN number is assigned to the applicant (block 713). A contract_status flag is set to “Approved”. This concludes information flow for the application acceptance process.

During the initial investment requesting process (FIG. 7B), an approved investor (block 720) sends an investment order (block 722) to the Investment Contract Web Site. If the investment amount is greater than or equal to the required minimum amount (block 726), then an Orders Table is populated with the amount and time of the fund transfer and an order_status flag is set to “Pending” (block 728). If the investment amount is less than the required amount, then an error message is sent to the approved investor (block 724), and the system accepts entry of a new amount from the approved investor.

With reference to FIG. 7C, the process of initial investment approval commences when an investor (block 730) wires or otherwise conveys money to the administrator (block 732). If the amount received equals the amount approved (as described in the context of FIG. 7B), then a status flag in an Investor Table is set to “Open”, and a status flag in a Contract Table is also set to “Open” (block 736). The previously-mentioned order_status flag in the Orders Table is set to “Complete”, and a transaction is thereby created (block 738).

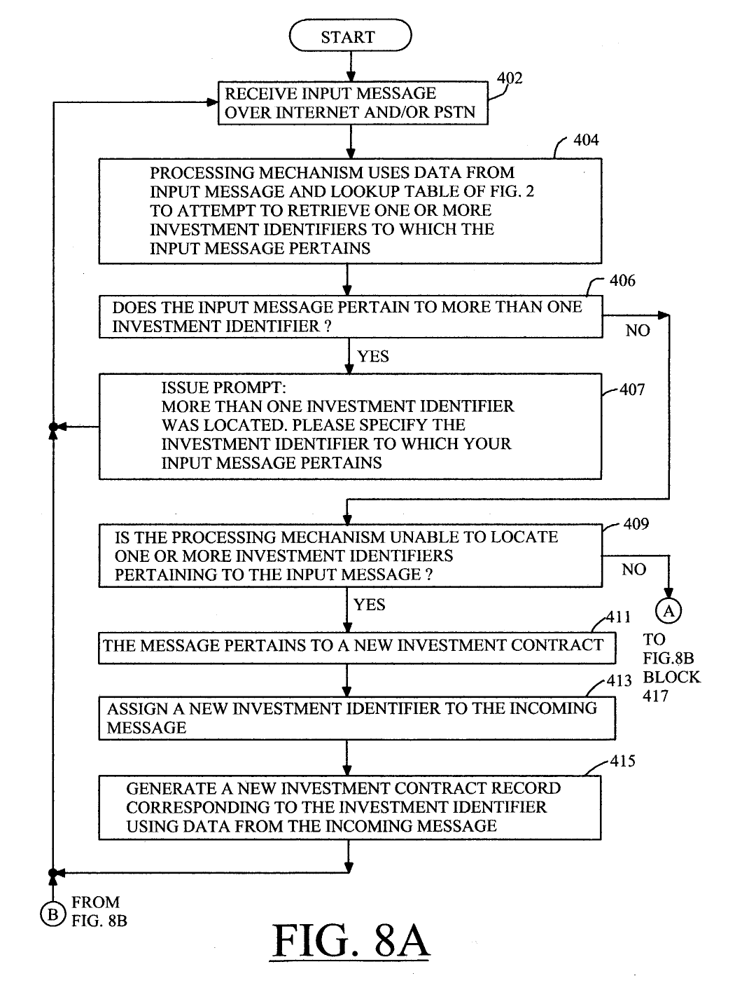

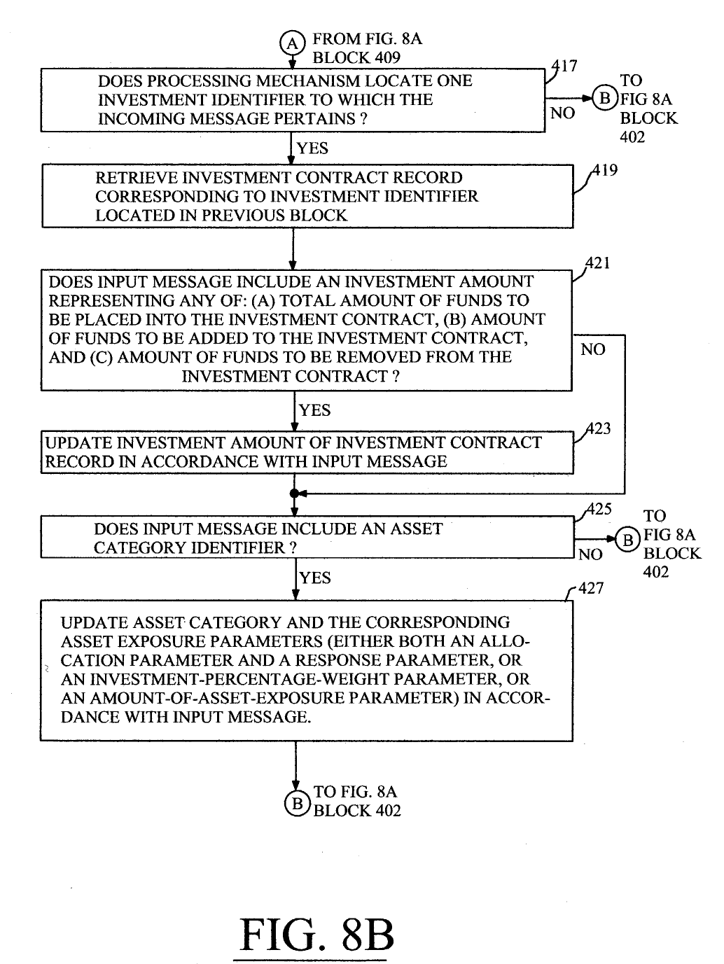

FIGS. 8A-8B together comprise a flowchart setting forth an operational sequence for generating and managing electronic investment contracts. At block 402, an input message is received over the Internet and/or over the Public Switched Telephone Network (PSTN) from an “approved” investor. Note that an investor's status as “approved” was previously determined at block 713 of FIG. 7A. The processing mechanism of the Investment Contract Web Site uses data from the input message and the lookup table of FIG. 2 to attempt to retrieve one or more investment identifiers to which the input message pertains (block 404). At block 406, a test is performed to ascertain whether or not the input message pertains to more than one identifier. If so, a prompt is issued: “More than one investment identifier was located. Please specify the investment identifier that your input message pertains to.” (block 407). The program then loops back to block 402.

The negative branch from block 406 leads to block 409 where a test is performed to determine whether or not the processing mechanism is unable to locate one or more investment identifiers pertaining to the input message. If not, the program jumps ahead to block 417, to be described in greater detail hereinafter. If so, the program progresses to block 411 where it is determined that the message pertains to a new investment contract. A new investment identifier is assigned to the incoming message (block 413), and a new investment contract record is generated, corresponding to the investment identifier, using data from the incoming message (block 415). The program then loops back to block 402.

Block 417 is reached from the negative branch of block 409. A test is performed to determine whether or not the processing mechanism is able to locate one investment identifier to which the message pertains. If not, the program loops back to block 402. If so, the program advances to block 419 where the investment contract record corresponding to the investment identifier located in the previous block is retrieved. At block 421, a test is performed to ascertain whether or not the input message includes an investment amount representing any of: (a) total amount of funds to be placed into the investment contract, (b) amount of funds to be added to the investment contract, and (c) the amount of funds to be removed from the investment contract. If such an input message is received, the investment amount of the investment contract record is updated in accordance with the input message (block 423).

Block 425 is reached from the negative branch of block 421, or after the operations of block 423 are performed. At block 425, a test is performed to determine whether or not the input message includes an asset category identifier. If not, the program loops back to block 402. If so, then the asset category and the corresponding asset exposure parameter(s), including at least one of: (a) both an allocation parameter and a response parameter, or (b) an investment-percentage-weight parameter, or (c) an amount-of-asset-exposure parameter, are updated in accordance with the input message at block 427. The program then loops back to block 402 (FIG. 8A).

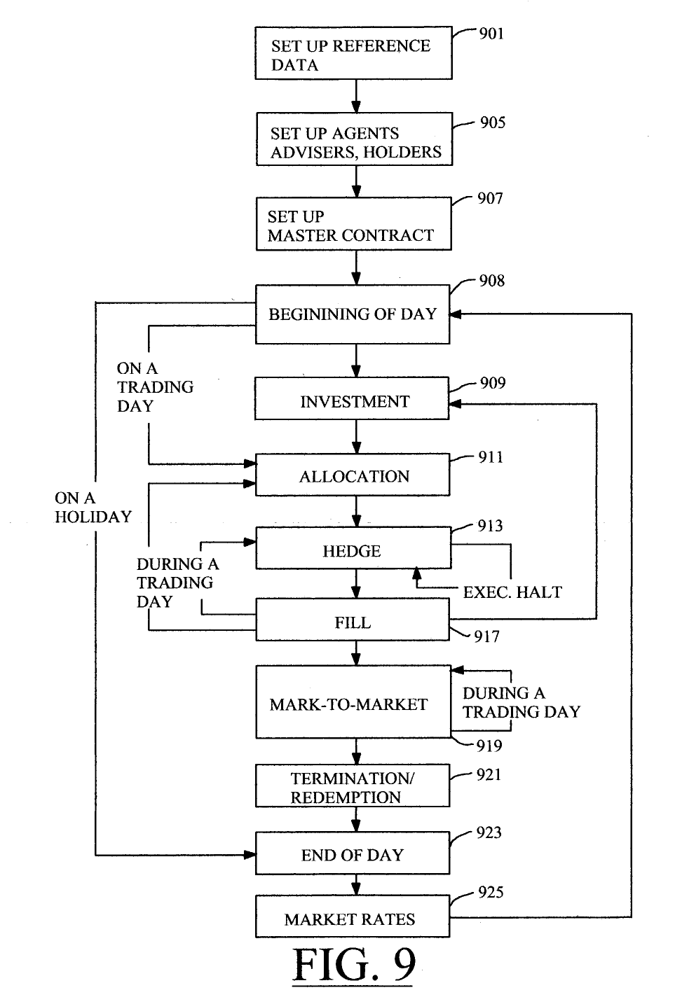

FIG. 9 is a flowchart setting forth a high-level operational sequence for managing investment contracts. The procedure commences at block 901 where reference data are set up. Such data includes, for example, the Country/Asset Category/Exchange Table of FIGS. 4A and 4B, as well as trading holidays for the various Exchanges, and a lookup table for various types of transactions. This lookup tables includes a plurality of transaction codes each specifying an order or type of investment, such as a redemption, an investment, or an allocation. Each transaction code is associated with a corresponding description of the transaction. This setting up of reference data is performed upon initial launch of the Investment Contract Web Site, or at any subsequent point in time when it is desired to change one or more items of reference data. At the beginning of every day (block 903), or at the beginning of another convenient defined time period, additional setup procedures are performed. When an investor is ready to sign up for the Investment Contract Web Site, the program sets up information on advisors and/or other agents for this investor at block 905. Next, at block 907, a Master Contract is set up. This Master Contract represents a plurality of individual investment contracts that an investment advisor will process as a group. Investor clients and/or individual contracts may be assigned to a group based upon the level of risk desired by that client and/or specified by that contract. The investment advisor then executes trades on behalf of the group, in view of the desired risk level.

At block 909, the client/investor wires, or otherwise conveys, investment funds to a custodian. After the receipt of funds is confirmed, the client/investor's contract balance is adjusted accordingly, and the program progresses to block 911 where an allocation procedure is performed. This procedure generates one or more pending orders based upon the allocation specified by the client/investor.

Once a predetermined time is reached, the program progresses to block 913. This predetermined time could be, for example, at the top of every hour or as frequently as every ten or fifteen minutes during days when one or more financial markets are open anywhere in the world. At block 913, all pending allocations for each asset category are “aggregated”, with buys offsetting “sells”, to determine a net buy or sell hedging order for each asset category. The hedging order for each asset category may, at the operator's discretion and/or automatically, be conveyed to a broker at block 917.

Orders conveyed to a broker are complete (filled) upon receiving a message (electronic or otherwise) from the broker indicating a confirmed amount and price for each order. For any order not conveyed to a broker, the program obtains a price from a data feed. For each asset category where the order is complete, the program establishes the asset price and gain/loss. If any order cannot be completed, it is included in the aggregation process the next time the program loops back to block 913.

The mark-to-market procedure of block 919 is performed after the aggregated order is filled, and may also be performed at the beginning of every trading day. This step determines the market value of a contract at any time by applying current market prices to each market position. For example, in the case of a market position that initially specified $1400 in the S&P 500 Index, a financial calculation is performed to determine the gain or loss and current market value of this position with respect to the corresponding investment contract.

The termination step of block 921 is only performed if the investor wishes to withdraw money from the investment contract. At this point, the value of the contract is known because a mark-to-market value calculation has just been performed. Finally, at the end of every trading day (block 923), or at the beginning of a new trading day, new market rates are received. These market rates may include the U.S. Treasury Bill rate, the EUBOR rate, the futures market rate, and/or the LIBOR rate, just to name a few illustrative examples.

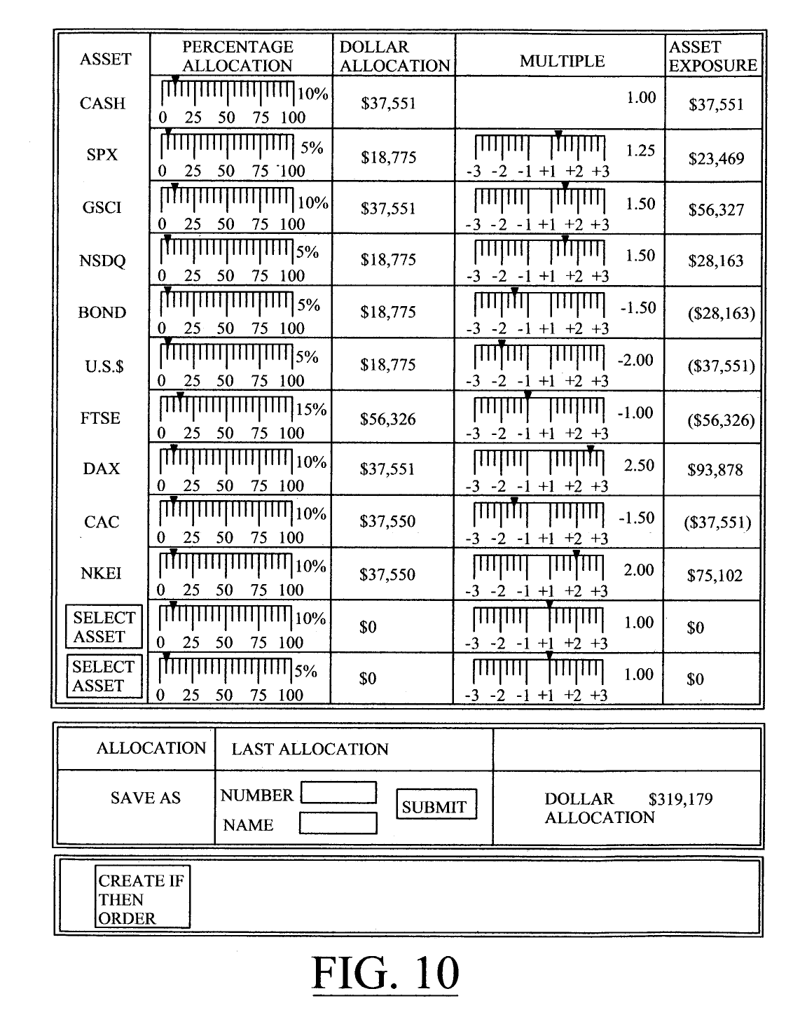

FIG. 10 is a screen-capture diagram showing an illustrative graphical user interface provided by the system of FIG. 1. Pursuant to a further embodiment of the invention, the electronic investment contracts are managed by means of an internet-accessible graphical user interface. The user interface provides a mechanism by which each asset category of one or more investment contracts can be maintained at a selected level of risk. The graphical user interface mechanism is coupled to a data processing mechanism that calculates an aggregate level of risk in a given asset category among a plurality of investment contracts. Based upon the aggregate level of risk, the data processing mechanism establishes an aggregate position to be established by purchases or sales of individual securities, purchases or sales of futures contracts in selected market indices, or other financial transactions related to that asset category. Electronic investment contract funds not required for the hedging process are invested in a mix of income-bearing instruments, such as U.S. Treasury Notes. As the investor changes the desired level of risk, or makes contract deposits and/or contract withdrawals, the data processing mechanism automatically adjusts the parameters related to their investment contract, and automatically initiates any required market transaction in the relevant asset category. Based upon market prices, each investment contract is updated in terms of exposure and net asset value. Optionally, an investment contract administration fee may be charged.

According to a still further embodiment of the invention, the graphical user interface provides a conditional order entry mechanism adapted to accept conditional if-then orders from an investor. The graphical user interface then forwards the conditional if-then order to the data processing mechanism. The data processing mechanism responds to conditional if-then investor requests such that, only upon the occurrence of the condition specified by the investor, one or more asset category identifiers, allocation parameters, and/or response parameters pertaining to the investor's investment contract are added or modified. In this manner, the net position of the investment contract reflects the level of risk desired by the investor.

It will be readily seen by one of ordinary skill in the art that the present invention fulfills all of the objects set forth above. After reading the foregoing specification, one of ordinary skill will be able to effect various changes, substitutions of equivalents, and various other aspects of the invention as broadly disclosed herein. It is, therefore, intended that the protection granted herein be limited only by the definitions contained in the appended claims and equivalents thereof.

We claim:

1. A computerized method for generating an electronic investment contract, the method comprising the steps of:
associating each of one or more investment identifiers with an investment amount and a respective one or more asset category identifiers; and
associating each of the respective one or more asset category identifiers with a corresponding asset exposure parameter that includes at least one of: (a) an allocation parameter associated with a response parameter, (b) an investment-percentage-weight parameter, and (c) an amount-of-asset-exposure parameter;
wherein each of respective investment identifiers uniquely specifies a corresponding investment contract;
wherein each of the respective one or more asset category identifiers uniquely specifies an investment asset category; and
wherein the asset exposure parameter specifies a relationship between the investment amount and subsequent price, percentage return, and/or relative valuation changes in, and/or net worth changes relating to, the corresponding investment asset category.

2. The computerized method of claim 1 wherein the asset exposure parameter includes at least one allocation parameter associated with a corresponding response parameter, wherein the allocation parameter specifies an allocation amount to be indexed to the corresponding asset category identifier, and wherein the response parameter specifies a relationship between (i) the allocation amount, and (ii) subsequent price, percentage return, and/or relative valuation changes in, and/or net worth changes relating to, the corresponding investment asset category.

3. The computerized method of claim 2 wherein, when the relationship between (i) the allocation amount, and (ii) subsequent price, percentage return, and/or relative valuation changes in, and/or net worth changes relating to, the corresponding investment asset category, is positive, this signifies a “long” investment position

4. The computerized method of claim 2 wherein, when the relationship between (i) the allocation amount, and (ii) subsequent price, percentage return, and/or relative valuation changes in, and/or net worth changes relating to, the corresponding investment asset category, is negative, this signifies a “short” investment position.

5. The computerized method of claim 1 wherein the asset exposure parameter is an investment-percentage-weight parameter that, when multiplied by the associated investment amount, yields an amount of asset exposure to the associated asset category

6. The computerized method of claim 5 wherein, when the investment-percentage-weight parameter is positive, this signifies a “long” investment position.

7. The computerized method of claim 5 wherein, when the investment-percentage-weight parameter is negative, this signifies a “short” investment position.

8. The computerized method of claim 5 wherein the sum of absolute values of all investment-percentage-weight parameters among all asset category identifiers for a given investment identifier is 100%, indicating no leveraging of the electronic investment contract corresponding to the given investment identifier.

9. The computerized method of claim 5 wherein the sum of absolute values of all investment-percentage-weight parameters among all asset category identifiers for a given investment identifier is greater than 100%, indicating a leveraging of the electronic investment contract corresponding to the given investment identifier.

10. The computerized method of claim 1 wherein the asset exposure parameter is an amount-of-asset-exposure parameter that is responsive to a subsequent price and/or relattive valuation change in, and/or net worth change relating to, the associated asset category.

11. The computerized method of claim 10 wherein, when the amount-of-asset-exposure parameter is positive, this signifies a “long” investment position.

12. The computerized method of claim 10 wherein, when the amount-of-asset-exposure parameter is negative, this signifies a “short” investment position.

13. The computerized method of claim 10 wherein the sum of absolute values of the amount-of-asset-exposure parameters among all asset category identifiers for a given investment identifier is equal to the corresponding investment amount, indicative of no leveraging of the electronic investment contract corresponding to the given investment identifier.

14. The computerized method of claim 10 wherein the sum of absolute values of the amount-of-asset-exposure parameters among all asset category identifiers for a given investment identifier is greater than the corresponding investment amount, indicative of leveraging of the electronic investment contract corresponding to the given investment identifier.

15. The computerized method of claim 1 further comprising the step of receiving an input enabling a determination of the investment identifier, and at least one of:
(a) the investment amount;
(b) the one or more asset category identifiers; and
(c) one or more respective asset exposure parameters to be associated with one or more corresponding asset category identifiers.

16. The computerized method of claim 15 wherein a computing mechanism associates each of the one or more investment identifiers with the one or more asset category identifiers, and associates each of the one or more asset category identifiers with the respective one or more asset exposure parameters, and wherein the input to the computing mechanism is received using at least one of:
(a) an electronic device coupled over the Internet to the computing mechanism; and
(b) a telephonic device coupled over the PSTN (public switched telephone network) to an IVR (interactive voice response) system and/or a speech recognition system, wherein the IVR and/or speech recognition system is coupled to the computing mechanism.

17. The computerized method of claim 15 wherein the step of receiving an input includes receiving one or more templates corresponding to a given investment identifier, each of respective templates setting forth a corresponding predefined asset exposure parameter or parameters for each of one or more asset category identifiers.

18. The computerized method of claim 17 further including the steps of receiving a template selection, wherein the template selection uniquely specifies one of the received templates corresponding to the given investment identifier; and the template so selected is then applied to an investment contract associated with the given investment identifier.

19. The computerized method of claim 17 further including the step of inputting a predefined condition to be associated with a specified one of the received templates, such that the specified one of the received templates is automatically applied to an investment contract associated with the given investment identifier upon occurrence of the predefined condition.

20. The computerized method of claim 19 wherein the predefined condition is at least one of:
(a) an occurrence of: a specified price, percentage return, and/or relative valuation of, and/or change in net worth relating to, one or more investment asset categories; and
(b) an occurrence of a specified date and/or time.

21. The method of claim 1 wherein each of one or more respective electronic investment contracts is held by a corresponding investor.

22. The method of claim 21 further including the step of determining an overall monetary value for each of the one or more respective electronic investment contracts.

23. The method of claim 22 wherein the electronic investment contract defines a financial relationship between a plurality of investors and a contract administrator such that, upon demand, the contract administrator shall convey the overall monetary value of the one or more respective electronic contracts held by a corresponding investor to that investor.

24. The method of claim 21 further including the step of calculating an aggregate position for an asset category by consolidating the asset exposure parameters associated with this asset category from a plurality of electronic investment contracts.

25. The method of claim 24 further including the steps of calculating aggregate positions for each of a plurality of asset categories.

26. The method of claim 25 further including the step of using the calculated aggregate positions to automatically generate purchase and/or sale orders for any of (a) futures contracts, (b) swaps, (c) contracts for differences, (d) securities, and (e) other financial instruments.

27. The method of claim 26 further including the steps of:
(a) determining an overall monetary value for each of the one or more respective electronic investment contracts, wherein the respective electronic investment contracts each define a financial relationship between a plurality of investors and a contract administrator such that, upon demand, the contract administrator has a payment obligation to convey the overall monetary value of the one or more respective electronic contracts held by a corresponding investor to that investor; and
(b) using the calculated aggregated positions to generate purchase and/or sales orders so as to enable the contract administrator to hedge the payment obligation.
